(19) United States
(12) Patent Application Publication
(10) Pub. No.: US 2008/0256395 A1
(43) Pub. Date: Oct. 16, 2008

(54) DETERMINING AND ANALYZING A ROOT CAUSE INCIDENT IN A BUSINESS SOLUTION

(76) Inventors: Carlos C. Araujo, Cary, NC (US); Ana C. Biazetti, Cary, NC (US); Metin Feridun, Thalwil (CH); Harrison H. Kim, San Mateo, CA (US); Juergen Schneider, Althengstett (DE)

Correspondence Address: HOFFMAN WARNICK LLC, 75 STATE ST, 14TH FLOOR, ALBANY, NY, 12207, US

(21) Appl. No.: 11/733,391

(22) Filed: Apr. 10, 2007

(51) Int. Cl. G06F 11/00; G06F 17/30

(52) U.S. Cl. 714/43; 707/3; 707/E17.014

(57) ABSTRACT

A method, system and computer program product for analyzing a state changing event are disclosed. According to an embodiment, a method for analyzing a state changing event comprises: detecting a state changing event of a first resource; tracing a dependence link beginning at the first resource to a resource that the first resource depends on until finding a second resource having a state changing event that is not dependent on any resource with a state changing event; and identifying the state changing event of the second resource as a root cause incident for analysis.

### FIELD OF THE INVENTION

The disclosure relates generally to a business solution, and more particularly to analyzing a state changing event of a component of a business solution to determine the root cause of the problem and its impact on the business solution.

### BACKGROUND OF THE INVENTION

In a typical business solution, a large number of information technology (IT) resources are combined and interact with one another to support a business process(es). The resources may be network devices, servers, applications, etc. The resources and business processes in a large scale deployment of a business solution may generate a large number of dependencies among one another such that a problem in one resource may affect other resources and business processes that are directly and/or indirectly dependent on it such that the problem can spread across the system producing a large number of other problems. As such, the success of such a complex business solution will depend on how accurately and quickly the real cause of the problems is determined and solved. That is, identifying the root cause of the problems is required to manage the system efficiently.

### BRIEF SUMMARY OF THE INVENTION

A first aspect of the invention is directed to a method for analyzing a state changing event, the method comprising: detecting a state changing event of a first resource; tracing a dependence link beginning at the first resource to a resource that the first resource depends on until finding a second resource having a state changing event that is not dependent one any resource with a state changing event; and identifying the state changing event of the second resource as a root cause incident for analysis.

A second aspect of the invention is directed to a system for analyzing a state changing event, comprising: means for detecting a state changing event of a first resource; means for tracing a dependence link beginning at the first resource to a resource that the first resource depends on until finding a second resource having a state changing event that is not dependent on any resource with a state changing event; and means for identifying the state changing event of the second resource as a root cause incident for analysis.

A third aspect of the invention is directed to a computer program product for analyzing a state changing event, the computer program product comprising: computer usable program code which, when executed by a computer system, enables the computer system to: receive data of a detected state changing event of a first resource; trace a dependence link beginning at the first resource to a resource that the first resource depends on until finding a second resource having a state changing event that is not dependent on any resource with a state changing event; and identify the state changing event of the second resource as a root cause incident for analysis.

Other aspects and features of the present invention, as defined solely by the claims, will become apparent to those ordinarily skilled in the art upon review of the following non-limiting detailed description of the invention in conjunction with the accompanying figures.

### BRIEF DESCRIPTION OF THE SEVERAL VIEWS OF THE DRAWINGS

The embodiments of this disclosure will be described in detail, with reference to the following figures, wherein:

FIG. 1 shows a schematic view of a system according to an embodiment of the invention.

FIG. 2 shows an illustrative example of a data structure in a relationship database according to an embodiment of the invention.

FIG. 3 shows a block diagram of an illustrative computing environment according to an embodiment of the invention.

FIG. 4 shows an embodiment of an operation of an event analysis system according to the invention.

It is noted that the drawings of the disclosure are not to scale. The drawings are intended to depict only typical aspects of the disclosure, and therefore should not be considered as limiting the scope of the invention. In the drawings, like numbering represents like elements among the drawings.

### DETAILED DESCRIPTION OF THE DISCLOSURE

The following detailed description of embodiments refers to the accompanying drawings, which illustrate specific embodiments of the invention. Other embodiments having different structures and operations do not depart from the scope of the present invention.

### 1. System Overview

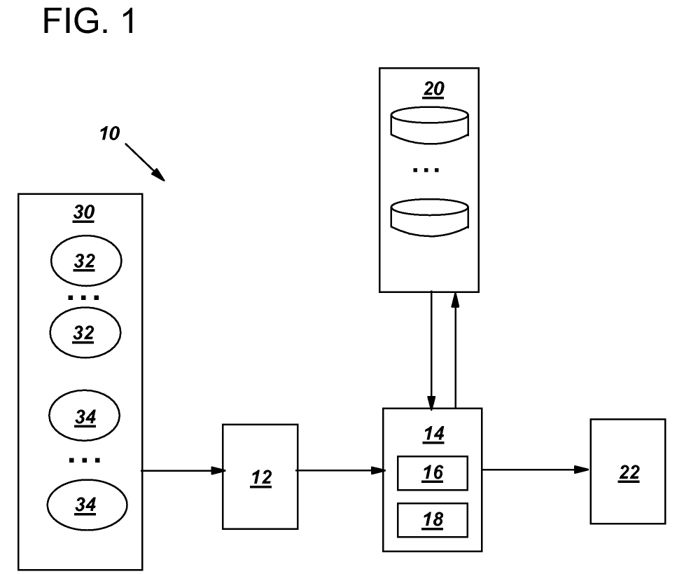

Referring to FIG. 1, a schematic view of an illustrative system 10 is shown. According to an embodiment, system 10 includes an event monitoring unit 12, an analysis unit 14 including a root cause determining unit 16 and a business impact assessing unit 18; a relationship database 20; and an impact solving unit 22. In operation, event monitoring unit 12 monitors the operation of a business solution system 30. Business solution system 30 includes at least one business process 32 that is supported by at least one resource 34. In the case that event monitoring unit 12 detects a state changing event of a resource 34 in business solution system 30, event monitoring unit 12 communicates the detected state changing event to analysis unit 14. A state changing event, hereinafter, an ‘event’, may be any change of the operation state of a resource 34. Upon receiving an event, root cause determining unit 16 determines a root cause of the event and impact assessing unit 18 assesses the possible impact of the root cause on business process 32. Analysis unit 14 queries relationship database 20 in performing the root cause determination and impact assessment.

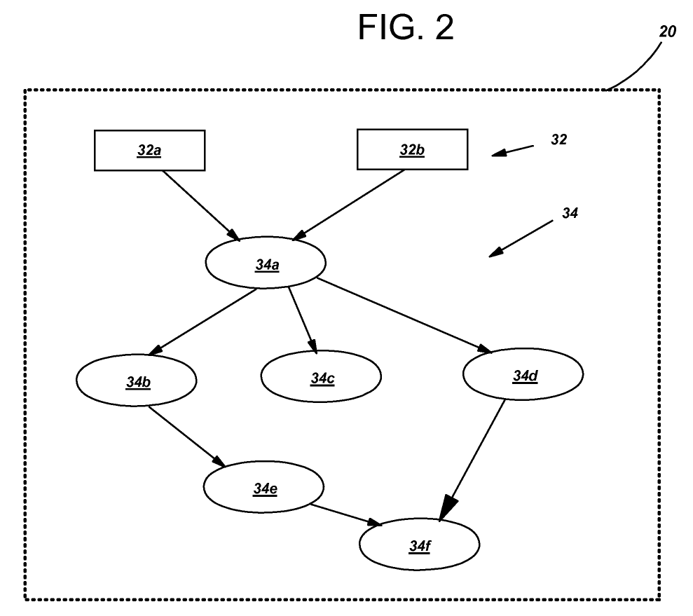

FIG. 2 shows an illustrative example of the data structure in relationship database 20. As shown in FIG. 2, nodes in the data structure, e.g., business processes 32 (32a and 32b are shown) and resources 34 (34a, 34b, 34c, 34d, 34e and 34f are shown), are related to one another through dependence links represented by the arrows. The direction of an arrow represents the dependence relationship between two nodes, i.e., resources 34 and/or business processes 32. Specifically, for example, the arrow from resources 34a to 34b represents/indicates that resource 34a depends on resource 34b. A dependence link may be traced from one end, e.g., business process 32a, to the other end, e.g., resource 34f, and may trespass intermediate nodes, e.g., resources 34a, 34b and 34e. Between two nodes within a dependence link, e.g., from business process 32a to resource 34f, the node, e.g., 34a, that depends on the other node, e.g., 34b, will be referred to as a ‘superior’ node, and the other node will be referred to as an ‘inferior’ node, for illustrative purposes only. As should be appreciated, a dependence link may be traced beginning at any node thereon, and in any direction, i.e., either following the arrows or traversing the arrows. As shown in FIG. 2, business processes 32a, 32b are on the superior end of dependence links, i.e., all business processes 32 are superior to respective resources 34 on the respective dependence link. It should be appreciated that in this description, a business process and a resource are differentiated only regarding a dependence link and a business process 32 refers to a node on the superior end of a dependence link. A ‘resource’ 34 may be a business process and may have another business process (either referred to as a ‘business process’ 32 or a ‘resource’ 34 depending on the relative position on the dependence link) depending on it. The designations of ‘resource’ and/or ‘business process’ do not limit the scope of the invention, and all kinds of dependent relationships between business processes 32 and resources 34 and/or among business processes 32 are possible and included. In addition, relationship database 20 also stores a latest state of a resource 34. In operation, the latest state of the resource 34 may be used to determine a state changing event thereof, e.g., via a state comparison.

As shown in FIG. 1, analysis unit 14 communicates the assessed business impact to impact solving unit 22 to act accordingly. Details of the operation of system 10 will be described herein together with a computer environment.

### 2. Computer Environment

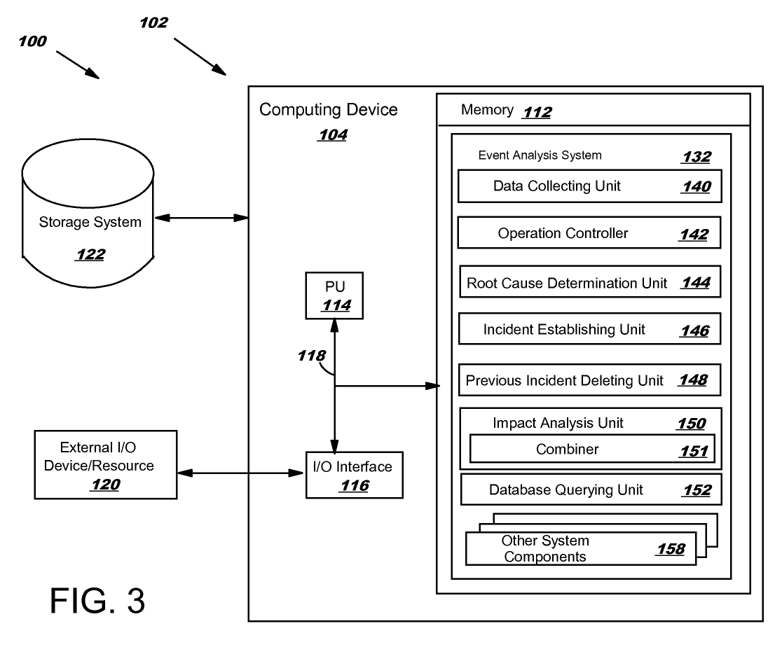

FIG. 3 shows an illustrative environment 100 for analyzing a state changing event of a business solution system 30 (FIG. 1). To this extent, environment 100 includes a computer infrastructure 102 that can perform the various processes described herein for analyzing a state changing event of business solution system 30 (FIG. 1). In particular, computer infrastructure 102 is shown including a computing device 104 that comprises an event analysis system 132, which enables computing device 104 to perform the process(es) described herein.

Computing device 104 is shown including a memory 112, a processor (PU) 114, an input/output (I/O) interface 116, and a bus 118. Further, computing device 104 is shown in communication with an external I/O device/resource 120 and a storage system 122. In general, processor 114 executes computer program code, such as event analysis system 132, that is stored in memory 112 and/or storage system 122. While executing computer program code, processor 114 can read and/or write data to/from memory 112, storage system 122, and/or I/O interface 116. Bus 118 provides a communications link between each of the components in computing device 104. I/O interface 116 can comprise any device that enables a user to interact with computing device 104 or any device that enables computing device 104 to communicate with one or more other computing devices. External I/O device/resource 120 can be coupled to the system either directly or through I/O interface 116.

In any event, computing device 104 can comprise any general purpose computing article of manufacture capable of executing computer program code installed thereon. However, it is understood that computing device 104 and event analysis system 132 are only representative of various possible equivalent computing devices that may perform the various processes of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in an embodiment, computer infrastructure 102 comprises two or more computing devices that communicate over any type of wired and/or wireless communications link, such as a network, a shared memory, or the like, to perform the various processes of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

Event analysis system 132 includes a data collecting unit 140; an operation controller 142; a root cause determination unit 144; an incident establishing unit 146; a previous incident deleting unit 148; an impact analysis unit 150 including a combiner 151; an database querying unit 152; and other system components 158. Other system components 158 may include any now known or later developed parts of event analysis system 132 not individually delineated herein, but understood by those skilled in the art.

According to an embodiment, computer infrastructure 102 and event analysis system 132 may be used to implement, inter alia, analysis unit 14 and relationship database 20 of system 10 (FIG. 1). For example, root cause determination unit 144 may be used, with others, to implement root cause determining unit 16 (FIG. 1); and incident establishing unit 146, previous incident deleting unit 148, and impact analysis unit 150 may be used together to implement impact assessing unit 18 (FIG. 1); and relationship database 20 may be implemented as a storage unit in storage system 122.

Inputs to computer infrastructure 102, e.g., through external I/O device/resource 120 and/or I/O interface 116, may include information communicated from event monitoring unit 12 regarding a detected event. Outputs to computer infrastructure 102, e.g., through external I/O device/resource 120 and/or I/O interface 116, may include results of the root cause determination and business impact assessment that are communicated to, e.g., impact solving unit 22 (FIG. 1) to act accordingly. The operation of system 10 and event analysis system 132 are described together herein in detail.

### 3. Operation Methodology

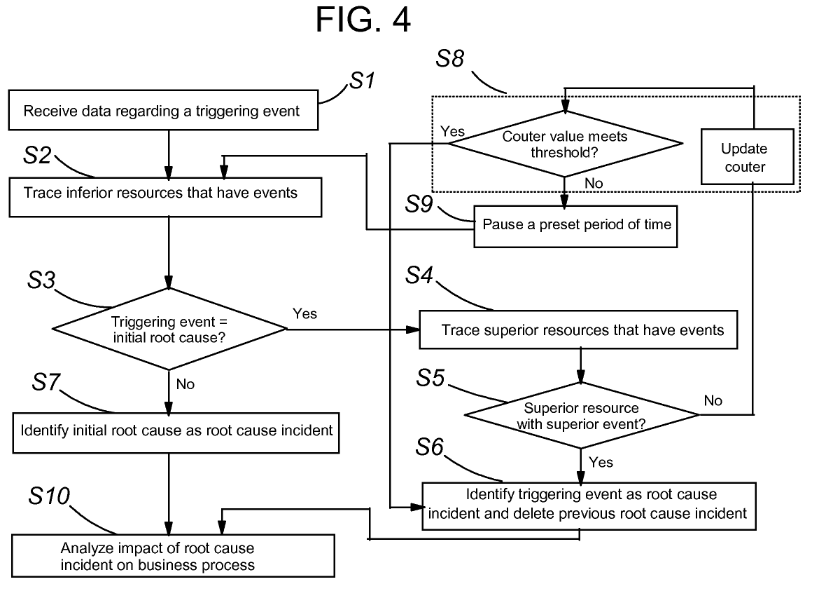

An embodiment of the operation of event analysis system 132 is shown in the flow diagram of FIG. 4. Referring to FIGS. 1-4, in process S1, data collecting unit 140 collects/receives data regarding an event of a resource 34 detected by event monitoring unit 12. Such an event will be referred to as a “triggering event” for illustrative purposes. Event monitoring unit 12 may detect an event using any method and/or mechanism and all are included. In addition, data regarding an event communicated between event monitoring unit 12 and data collecting unit 140 may be in any mutually recognized format and content. For example, the event data may identify the event and the respective resource 34. Alternatively, the event data may only identify the specific event and event analysis system 132 may identify the respective resource 34. In the following description, it is assumed that resource 34b has been detected as having a triggering event, for illustrative purposes.

In process S2, root cause determination unit 144 traces a dependence link beginning at the resource 34 having the ‘triggering event’, e.g., resource 34b, to an inferior resource 34, until finding a resource 34 that has an event and is not dependent of any resource 34 with an event. The event of the found resource 34 is referred to as an ‘initial root cause’. Note that the triggering event may be found as the initial root cause. According to an embodiment, root cause determination unit 144 coordinates with database querying unit 152 to query relationship database 20 to trace the dependence link(s). It should be appreciated that multiple ‘initial root causes’ may be found in process S2. For example, in the case that resource 34a has a ‘triggering event’, it may be found that resources 34b, 34c and 34d all have events, and in the case that resources 34e and 34f have no events, the events on resources 34b, 34c and 34d will all be identified as ‘initial root causes’ to the ‘triggering event’ of resource 34a. Here, for illustrative purposes, it is assumed that resource 34b itself is found as the ‘initial root cause’. That is, tracing dependence link from resource 34b to inferior resource 34e, root cause determination unit 144 finds that resource 34e does not have an event.

In process S3, operation controller 142 determines whether the ‘initial root cause’ is the ‘triggering event’ itself. If the ‘initial root cause’ is not the ‘triggering event’, operation controller 142 controls the operation to process S7, where incident establishing unit 146 identifies the ‘initial root cause’ as a root cause incident’. If the ‘initial root cause’ is the ‘triggering event’, here, e.g., resource 34b, operation controller 142 controls the operation to process S4.

In process S4, previous incident deleting unit 148 traces a dependent link beginning at the resource with the ‘triggering event’, here resource 34b, to a superior resource 34 (i.e., a resource 34 that depends on resource 34b) that has a state changing event. The event of the ‘superior resource’ 34 is referred to as ‘superior event’ for illustrative purposes. Here, for illustrative purposes, it is assumed that resource 34a has been found as having a ‘superior event’.

In process S5, operation controller 142 determines whether there is a ‘superior resource’ 34 having a ‘superior event’. If there is such a ‘superior resource’, operation controller 142 controls the operation to process S6. In process S6, incident establishing unit 146 identifies the triggering event, here the event of resource 34b, as a root cause incident, and previous incident deleting unit 148 deletes an root cause incident, if any, previously established for the ‘superior event’. If no such ‘superior resource’ 34 is found, operation controller 142 updates a counter and determines whether the counter value reaches a threshold in process S8. If the counter value does not reach the threshold, operation controller 142 controls the operation to pause for a preset period of time in process S9, and then go to process S2 to trace an ‘initial root cause’ again. If the counter value reaches the threshold, operation controller 142 controls the operation to process S6.

In process S10, impact analysis unit 150 analyzes an impact of the root cause incident by tracing a dependence link beginning at the resource 34, here 34b, having the root cause incident to a business process 32 depending on the resource 34, here 34b. Impact assessing unit 150 may coordinate with database querying unit 152 to implement the tracing via relationship database 20. After the dependence link(s) from the resource 34 having the root cause incident to business processes 32 has been identified, impact analysis unit 150 may analyze the potential impact of the root cause incident following the identified dependence link(s). For example, with respect to FIG. 2, impact assessing unit 150 will analyze the impact of the root cause incident of resource 34b on resource 34a, and then the impact of resource 34a state change on business processes 32a and 32b. In process S10, optionally, in the case that multiple business processes 32 are dependent on the resource 34 having the root cause incident, e.g., business processes 32a and 32b both depend on resource 34b, combiner 151 combines the impact of the root cause incident on the multiple business processes 32. According to an embodiment, combiner 151 may assign a weight to each of the multiple business processes 32 to combine the respective impacts.

### 4. Conclusion

While shown and described herein as a method and system for analyzing a state changing event, it is understood that the disclosure further provides various alternative embodiments. For example, in an embodiment, the invention provides a program product stored on a computer-readable medium, which when executed, enables a computer infrastructure to analyze a state changing event to determine the root cause of the problem and its impact on the business solution. To this extent, the computer-readable medium includes program code, such as event analysis system 132 (FIG. 3), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 3) and/or storage system 122 (FIG. 3), and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for analyzing a state changing event, the method comprising:
detecting a state changing event of a first resource;
tracing a dependence link beginning at the first resource to a resource that the first resource depends on until finding a second resource having a state changing event that is not dependent on any resource with a state changing event; and
identifying the state changing event of the second resource as a root cause incident for analysis.

2. The method of claim 1, further comprising tracing a dependence link beginning at the first resource to a third resource that depends on the first resource and has a state changing event.

3. The method of claim 2, in response to a root cause incident being previously established for the state changing event of the third resource, further comprising deleting the previous root cause incident.

4. The method of claim 1, in response to the second resource being the first resource itself, further comprising performing another tracing after a preset period of time.

5. The method of claim 1, further comprising analyzing an impact of the root cause incident by tracing a dependence link beginning at the second resource to a process depending on the second resource.

6. The method of claim 1, in response to multiple processes depending on the second resource, further comprising integrating impacts of the root cause incident on the multiple processes by assigning weights to the multiple processes.

7. The method of claim 1, wherein the dependency link and a latest state of a resource are queried from a relationship database, the latest state of the resource being used to determine a state changing event of the resource.

8. A system for analyzing a state changing event, comprising:
means for detecting a state changing event of a first resource;
means for tracing a dependence link beginning at the first resource to a resource that the first resource depends on until finding a second resource having a state changing event that is not dependent on any resource with a state changing event; and
means for identifying the state changing event of the second resource as a root cause incident for analysis.

9. The system of claim 8, further comprising means for tracing a dependence link beginning at the first resource to a third resource that depends on the first resource and has a state changing event.

10. The system of claim 9, in response to a root cause incident being previously established for the state changing event of the third resource, the third resource tracing means further deletes the previous root cause incident.

11. The system of claim 8, in response to the second resource being the first resource itself, the tracing means further performs another tracing after a preset period of time.

12. The system of claim 8, further comprising means for analyzing an impact of the root cause incident by tracing a dependence link beginning at the second resource to a process depending on the second resource.

13. The system of claim 8, in response to multiple processes depending on the second resource, further comprising means for integrating impacts of the root cause incident on the multiple processes by assigning weights to the multiple processes.

14. The system of claim 8, further comprising a relationship database to store the dependence link and a latest state of a resource, the latest state of the resource being used to determine a state changing event of the resource.

15. A computer program product for analyzing a state changing event, the computer program product comprising:
computer usable program code which, when executed by a computer system, enables the computer system to:
receive data of a detected state changing event of a first resource;
trace a dependence link beginning at the first resource to a resource that the first resource depends on until finding a second resource having a state changing event that is not dependent on any resource with a state changing event; and
identify the state changing event of the second resource as a root cause incident for analysis.

16. The program product of claim 15, wherein the program code is further configured to enable the computer system to trace a dependence link beginning at the first resource to a third resource that depends on the first resource and has a state changing event.

17. The program product of claim 16, wherein, in response to a root cause incident being previously established for the state changing event of the third resource, the program code is further configured to enable the computer system to delete the previous root cause incident.

18. The program product of claim 15, wherein, in response to the second resource being the first resource itself, the program code is further configured to enable the computer system to perform another tracing after a preset period of time.

19. The program product of claim 15, wherein the program code is further configured to enable the computer system to analyze an impact of the root cause incident by tracing a dependence link beginning at the second resource to a process depending on the second resource, and in response to multiple processes depending on the second resource, the program code is further configured to enable the computer system to integrate impacts of the root cause incident on the multiple processes by assigning weights to the multiple processes.

20. The program product of claim 15, wherein the program code is configured to enable the computer system to query a relationship database to obtain the dependency link and a latest state of a resource, and to use the latest state of the resource to determine a state changing event of the resource.
